(19) United States
(12) Patent Application Publication
(10) Pub. No.: US 2005/0065995 A1
(43) Pub. Date: Mar. 24, 2005

(54) Content and task-execution services provided through dialog-based interfaces

(75) Inventors: David Milstein, Redmond, WA (US); Linda Criddle, Kirkland, WA (US)

Correspondence Address: Christopher L. Holt;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/668,438

(22) Filed: Sep. 23, 2003

(51) Int. Cl. G06F 15/16

(52) U.S. Cl. 709/202

(57) ABSTRACT

A client-server interaction scheme is disclosed and enables content to be retrieved, or a task to be executed, through user instructions embedded in dialog-based user communication with a specialized simulated entity. Generally speaking, the scheme involves communication between a user device having a dialog-based user interface and a communication service provider, the communication typically taking place over some form of a network. In accordance with one aspect of the present invention, a user utilizes traditional, dialog-based, person-to-person type interaction to request and receive information from a non-human source. The user interacts with the non-human source in a manner substantially similar to how they would typically interact with another person. The user interactions are analyzed and translated into calls not only for informational content, but also calls for action to be taken on behalf of the user.

### BACKGROUND OF THE INVENTION

The present invention generally pertains to a method for providing content and/or task-execution services to a user. More particularly, the present invention pertains to a method for providing content and/or task-execution services based on a user's dialog-based communication with a communication service accessed through any of a variety of interfaces.

There are known systems that enable a user to interact with a server to retrieve information, or to remotely perform a task. The typical known system, however, requires a user to utilize specialized software that is maintained on the user's client machine. The software typically operates in association with its own user interface, which is not always user-friendly, and often requires familiarity with a relatively complex collection of specialized command words. As the client-side software is updated or expanded upon, all copies must be updated. If a user purchases a new device, a new copy of the client-side software must be obtained, installed, and in many cases re-configured. The client-side software generally takes up memory space on every device utilized to interact with the server. This use of space is of concern, especially for devices, such as cell phones and mobile computing devices, which can have a relatively limited storage capacity.

In many instances, client-side software utilized to interact with a server varies dramatically from one device to another. For example, the user interface can be significantly inconsistent from one computing device to the next. Presently, it is relatively difficult for a user to efficiently interact with a server to access content, or to remotely perform a task, when the user does not have access to a personal computer. There is a need for a consistent client interface that provides a relatively standard way to interact with a server regardless of the size or mobility of a given computing device.

Finally, it is not uncommon for users to be required to load and interact with multiple user interfaces to accomplish multiple server interactions. For example, a first user interface might be required to pay a bill, a second to retrieve sports-related content, and a third to edit a calendar-based schedule. There is a need for a single intuitive interface that can be utilized to effectuate transactions across multiple applications that would traditionally be accessed through separate and independent user interfaces.

### SUMMARY OF THE INVENTION

Embodiments of the present invention generally pertain to a client-server interaction scheme that enables content to be retrieved, or a task to be executed, through user instructions embedded in dialog-based user communication with a specialized simulated entity. Generally speaking, the scheme involves communication between a user device having a dialog-based user interface and a communication service provider, the communication typically taking place over some form of a network. In accordance with one aspect of the present invention, a user utilizes traditional, dialog-based, person-to-person type interaction to request and receive information from a non-human source. The user interacts with the non-human source in a manner substantially similar to how they would typically interact with another person. The user interactions are analyzed and translated into calls not only for informational content, but also calls for action to be taken on behalf of the user.

### BRIEF DESCRIPTION OF THE DRAWINGS

FIG. 1 is a schematic block diagram of an exemplary computing environment.

FIG. 2 is a block diagram of an exemplary computing environment.

FIG. 3 is a simplified pictorial illustration of a mobile device.

FIG. 4 is a simplified pictorial illustration of a mobile device.

FIG. 5 is a schematic block diagram representing a dialog-based content retrieval system.

FIG. 6 is a schematic block diagram representing a dialog-based content retrieval system.

FIG. 7 is an illustration of an exemplary screen shot.

FIG. 8 is an illustration of an exemplary screen shot.

FIG. 9 is an illustration of an exemplary screen shot.

FIG. 10 is a schematic block diagram representing a dialog-based task execution system.

FIG. 11 is a schematic block diagram illustrating a dialog-based task-execution system.

FIG. 12 is a flow chart representing steps associated with retrieving content utilizing a dialog-based system.

FIG. 13 is a flow chart representing steps associated with executing a subscription-oriented, dialog-based content retrieval system.

FIG. 14 is a flow chart representing steps associated with task-execution utilizing a dialog-based system.

### DETAILED DESCRIPTION OF ILLUSTRATIVE EMBODIMENTS

I. A Mobile Environment

For the purpose of providing a context for the description of the present invention, a few specific computing system environments within which embodiments of the present invention are applicable will be described. However, the present invention is operational with numerous general purpose or special purpose computing systems, as well as various networked configurations thereof. Examples of well-known computing systems, environments, and/or configurations that are suitable to accommodate embodiments of the present invention include, but are not limited to, personal computers, server computers, hand-held or laptop devices, multiprocessor systems, microprocessor-based systems, set top boxes, programmable consumer electronics, network PCs, minicomputers, mainframe computers, telephone systems, distributed computing environments that include any of the above systems or devices, and any networked configurations thereof.

Further, the present invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by a remote processing devices that are linked through a communications network. In a distributed computing environment, program modules may be located in local and/or remote storage media including memory storage devices.

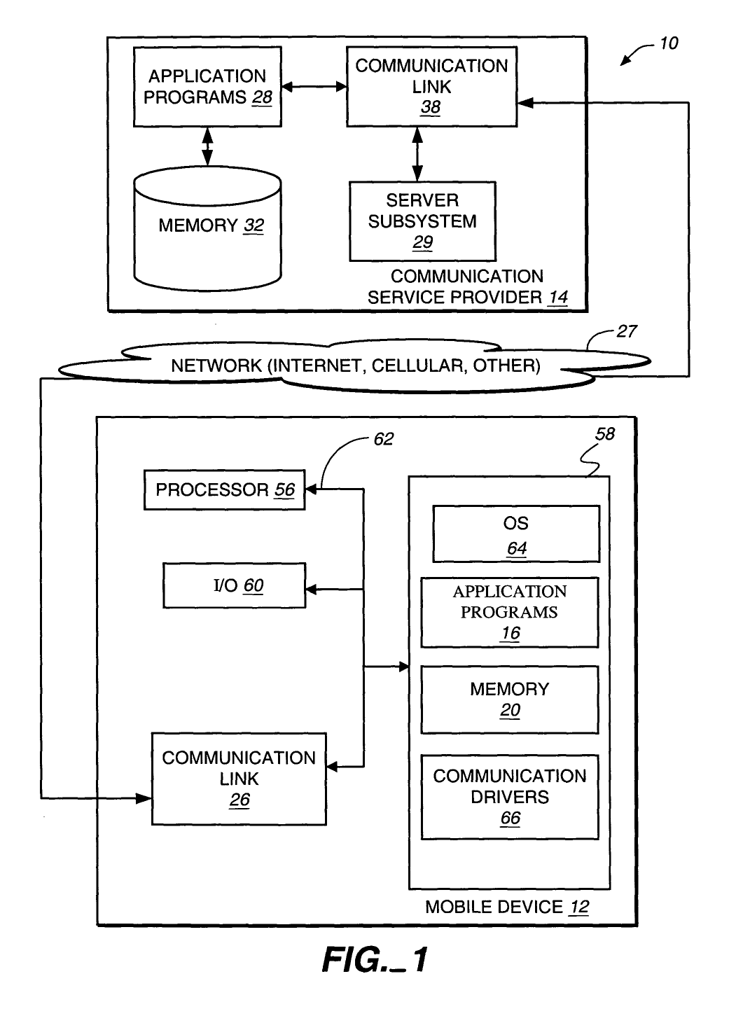

FIG. 1 is a block diagram of an illustrative environment 10 within which embodiments of the present invention can be implemented. Environment 10 includes a mobile device 12 and a communication service provider 14. Communication service provider 14 includes application programs 28, a memory 32, a server subsystem 29 and a communication link 38. Mobile device 12 includes application programs 16, a program memory 20 and communication link 26. Mobile device 12 also includes memory 58, microprocessor 56, operating system 64, input/output (I/O) components 60 and communication drivers 66. Components of mobile device 12 are illustratively coupled for communication with one another over a suitable buss 62. It will be appreciated that both mobile device 12 and computing device 14 include a number of other non-illustrated components.

Referring to mobile device 12, memory 58 is preferably implemented as non-volatile electronic memory such as random access memory (RAM) with a battery back-up module (not shown) such that information stored in memory 58 is not lost when the general power to mobile device 12 is shut down. A portion of memory 58 is illustratively allocated as addressable memory for program execution, while another portion of memory 58 is optionally used for storage, such as to simulate storage on a disc drive. Memory 58 includes operating system 64, as well as one or more application programs 16 and corresponding memory structure 20. Application programs 16 may illustratively include a program (e.g., a GPS program) that is configured to identify a location of mobile device 12, such as location within a geographical coordinate system (e.g., latitude/longitude coordinates).

Operating system 64 is executed during operation by processor 56 from memory 58. The operating system 64 implements features that can be utilized by application programs 16 through a set of exposed application programming interfaces and methods. I/O components 60, in one embodiment, are provided to facilitate input and output operations in association with a user of mobile device 12. I/O components 60 for various embodiments of mobile device 12 can include input components such as buttons and touch sensors, as well as output components such as a display, a speaker, and/or a printer port. Other I/O components are conceivable and within the scope of the present invention.

Communication link 26 can be any of a variety of known suitable communication interfaces. The function of link 26 is generally to enable communication with communication service provider 14 through network 27. Network 27 can be any of a variety of known communications networks including but not limited to the Internet and a cellular communications network. Memory 58 includes a set of communication drivers 66 that interact with communication link 26, and that translate data to and from the appropriate communication protocol necessary to enable communication across the link 26 through network 27.

In one illustrative embodiment of the present invention, application programs 16 include one or more dialog-based communication programs such as, but not limited to an email application, an instant messaging application and/or an SMS (Short Message Service) application. Communication service provider 14 is configured to support the dialog-based communication programs as they are executed by a user of mobile device 12. The dialog-based communication programs enable a user of mobile device 12 to communicate with at least one other individual through a dialog-based interface (e.g., an email interface, a chat message interface, etc.) As will be explained in detail in relation to other Figures, in accordance with one aspect of the present invention, a user of device 12 communicates with a computer simulated “person” through dialog-based communication. Through this dialog-based communication, the user of device 12 makes calls to server subsystem 29 for specialized content and/or action to be carried out. In this manner, the simulated “person” essentially can deliver requested content to the user and/or perform tasks on behalf of the user.

Application programs 16 may also include Personal Information Manager (PIM) programs, which support, for example, electronic mail messaging, scheduling, calendering, personal accounting, automatic bill paying, etc. Of course, application programs 16 can include other applications configured to support any of a wide variety of other program features, such as task lists and personalized address books, to name a few. Memory 20 is configured to store a plurality of individual records or objects, each comprising a plurality of fields or properties related to application programs 16.

Application programs 28 can include any of a variety of conventional features and functions. Application programs 28 include programs designed to support programs 16 such as a server-side email program, an instant messaging program and/or an SMS program. Application programs 28 can also include programs designed to be remotely utilized by an operator of mobile device 12 to manage personal data. Such programs can include PIM programs, which support, for example, electronic mail messaging, scheduling, calendaring, personal accounting and financing, task listing, address booking, making travel arrangements, automatic bill paying, etc. Of course, application programs 28 can include other applications configured to support any of a wide variety of other program features.

In accordance with one aspect of the present invention, when a user of mobile device 12 interacts with a simulated “person” as described above, server subsystem 29 is directed to interact with a PIM program, or other program remotely accessed or in programs 28 or 16, on the user's behalf. In this manner, the simulated “person” essentially enables the user to perform a program task without directly accessing the program's particular user interface. The simulated person can perform any of a variety of functions for the user, such as adding a date to a calendar, canceling a flight reservation, paying a bill, etc. Memory 32 is configured to store a plurality of individual records or objects, each comprising a plurality of fields or properties related to the application programs. A user can interact with the simulated “person” to have server subsystem 29 deliver content to device 12. The content delivered to the user through device 12 may be the user's data stored in memory 32, or may be content that originates from a third-party source (e.g., ESPN, MSNBC, etc.). These simulated “person” systems will be described below in detail in relation to other Figures.

Communication service provider 14 and mobile device 12 communicate with each other through two-way communication links 26 and 38. Communication links 26 and 38 are illustratively commercially available communication links that implement a suitable communications protocol. For example, in a direct connection embodiment, mobile device 12 is connected to communication service provider 14 with a physical cable that communicates utilizing a serial communication protocol. Other communication mechanisms are also contemplated by the present invention, such as but not limited to infra-red (IR) communication, direct modem communication, remote dial-up-networking communication, communication through commercially available network cards (e.g., using TCP/IP), remote access services (RAS), wireless modem communication, wireless cellular digital packet data (CDPD), wireless Bluetooth™ communication, FireWire communication, or any other suitable communication mechanism or means. Although the communication links are shown as being internal to mobile device 12 and communication service provider 14, those skilled in the art will recognize that at least portions of the communication links may exist outside of the devices.

It should be noted that devices 12 and 14 are only examples of devices suitable to support the present invention and are not intended to suggest any limitation as to the scope of use or functionality of the present invention. Neither should devices 12 and 14 be interpreted as having any dependency or requirement relating to any one or combination of components illustrated in FIG. 1.

II. A Personal Computer Environment

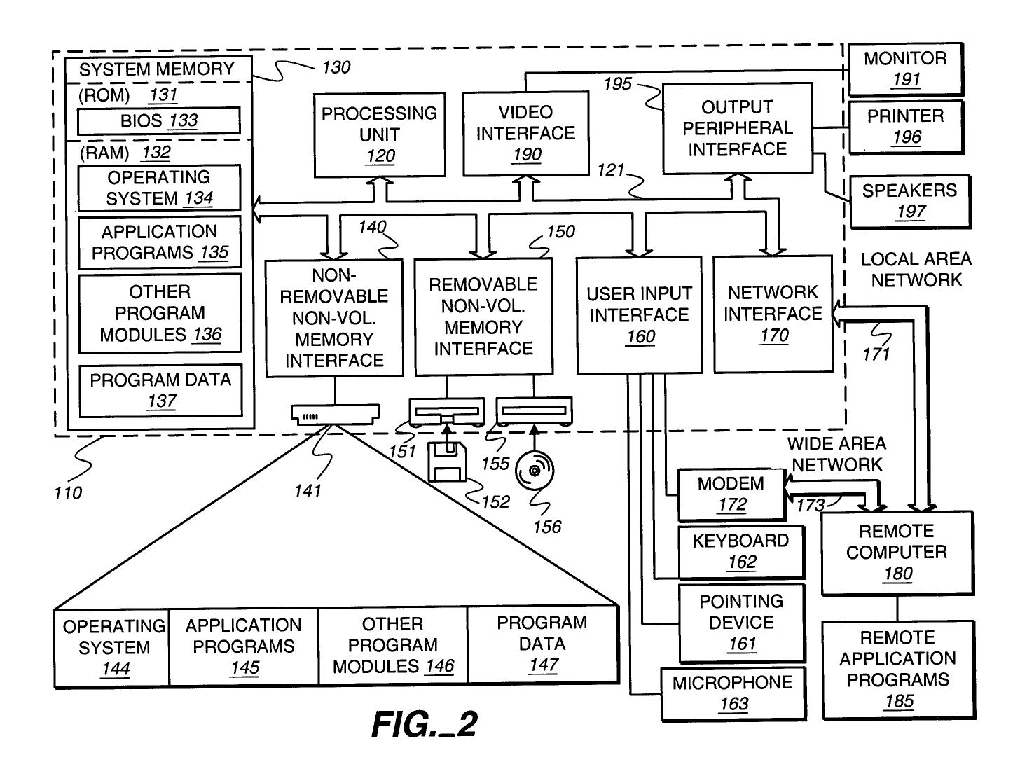

FIG. 2 is a block diagram of an exemplary computing environment within which embodiments of the present invention can be implemented. The Figure presents a general-purpose computing device in the form of a computer 110. Computer 110 is illustratively configured to generally operate as either of devices 12 and 14 described in relation to FIG. 1, but is particularly well suited to operate in place of mobile device 12. Computer 110 can be configured to operate the same as, and perform any of the described functions of, mobile device 12.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180, which can include mobile device 12. The remote computer 180 may be a personal computer, a hand-held device, a server, a router, a network PC, a peer device or other common network node, and typically includes many or all of the elements described above relative to the computer 110. The logical connections depicted in FIG. 2 include a local area network (LAN) 171 and a wide area network (WAN) 173, but may also include other networks. Such networking environments are commonplace in offices, enterprise-wide computer networks, intranets and the Internet. In addition, the network connections between any of the nodes in the network may include direct cable connections or wireless connections and the connection between computer 110 and remote computer 180 may include any number of nodes and/or routers.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on remote computer 180. It will be appreciated that the network connections shown are exemplary and other means of establishing a communications link between the computers may be used.

III. Examples of Mobile Device 12

A mobile device 12 was described in relation to FIG. 1. In order to provide context for the embodiments of the present invention, a few specific examples of mobile devices configured to operate as the depicted device 12 are described immediately hereafter.

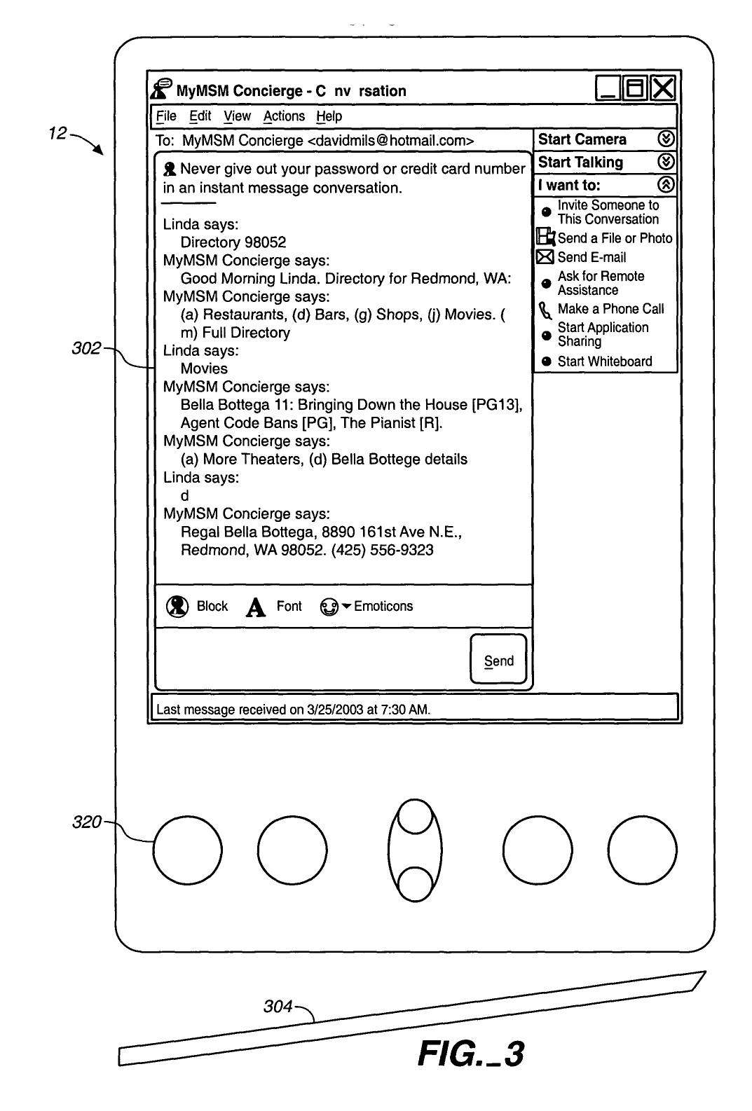

FIG. 3 is a simplified pictorial illustration of one embodiment of a specific mobile device 12. Mobile device 12, as shown in FIG. 3, includes a screen 302 that can sense the position of stylus 304 relative to the screen and thereby allow the user to select objects on the screen, as well as write and draw through screen input. The mobile device 12 shown in FIG. 3 also includes a number of user input keys or buttons, such as button 320, which allow the user to scroll through menu options or other display options which are displayed on display 302, or which allow the user to change applications or select user input functions, without contacting display 302.

It should be noted that display 302 will typically be much smaller than a conventional display used with a desktop computer. For example, display 302 may be defined by a matrix of only 240×320 coordinates or 160×160 coordinates, or any other suitable size. It is conceivable that mobile device 12 could be a pager, and in such case, the display may be even smaller than described.

Although not illustrated, the mobile device 12 of FIG. 3 also includes an antenna that supports wireless communication with the device. Also included are one or more communication ports, such as a serial or USB port, or a Local Area Network (LAN) port, that support wired communication.

The mobile device 12 of FIG. 3 is illustrated with a dialog-based instant messaging application operating thereon. Device 12 is illustratively configured to interact with an instant message server (e.g., communication service provider 14 in FIG. 1) to enable instant message functionality, as is known in the art. Mobile device 12 could just as easily be configured to interact with an email transport system to enable email functionality, or with an SMS system to enable SMS messaging. These are just several examples of dialog-based interfaces for which mobile device 12 can be configured.

It should be noted that the specific content illustrated on display 302 is consistent with at least one aspect of the present invention. The content demonstrates an instant messaging conversation between a user of device 12 and a simulated “person”. The user is interacting with the simulated person in order to initiate a retrieval of content. The user is effectively utilizing the simulated “person” to instruct server subsystem 29 (FIG. 1) to retrieve content. The content is illustratively delivered through the simulated “person” format. These aspects of the present invention will be discussed below in detail in relation to other Figures.

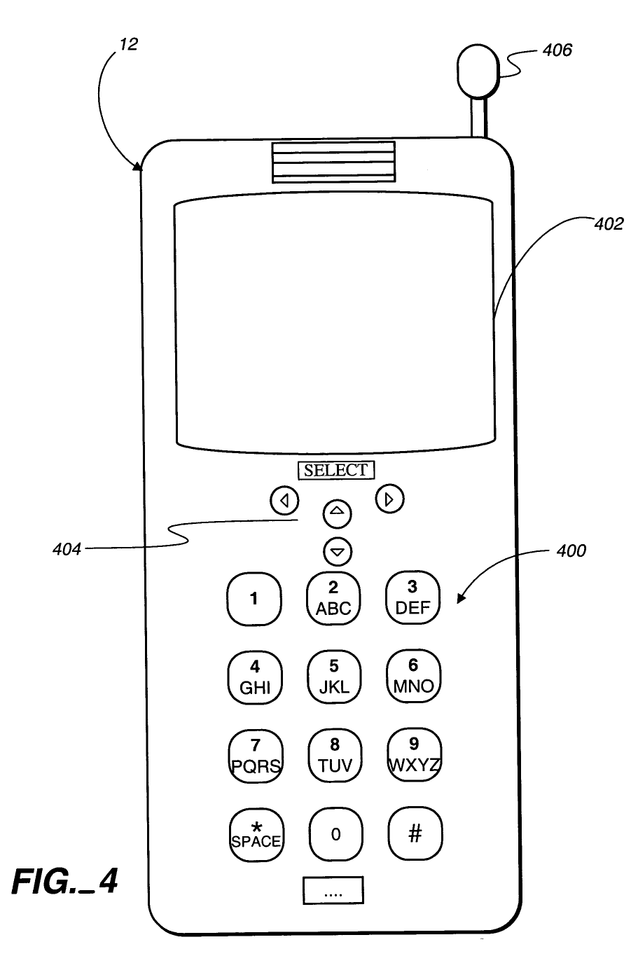

FIG. 4 provides a pictorial diagram of a phone embodiment of a mobile device 12. The phone includes a set of keypads 400 for dialing phone numbers, a display 402 capable of displaying application images, and control buttons 404 for selecting items shown on the display. The phone includes an antenna 406 for receiving and sending cellular phone signals such as General Packet Radio Service (GPRS) and 1Xrtt, and Short Message Service (SMS) signals. When operating in association with a cellular phone signal, the phone establishes a connection with a carrier. Generally, the carrier charges a fee based on the length of time that this connection is maintained.

The phone of FIG. 4 is illustratively configured to support some form of textual dialog-based communication including but not limited to instant messaging, text messaging and/or email. Such communication is illustratively supported by a remotely accessed communication service provider (e.g., service provider 14 in FIG. 1). A user of the phone can illustratively utilize these textual communication means to interact with a simulated “person” as described above.

Another form of dialog-based communication for which phone 12 is configured is traditional speech communication. In accordance with one aspect of the present invention, a user of phone 12 can utilize traditional speech communication dialog in association with a specialized phone call system to request content and/or the performance of services. For example, communication service provider 14, which illustratively incorporates the specialized phone call system, is accessed by phone 12 through a conventional or cellular telephone network. The user interacts with a simulated or real person through traditional, dialog-based, telephone speech interaction. The system can also, or alternatively, be configured for interaction with the user based on non-speech input such as, but not limited to, touch-tone item selection, as is known in the art.

It should be noted that devices other than those specifically described herein are possible and within the scope of the present invention. Other examples include tablet PCs and wireless-enabled lap-top computers.

IV. Overview of Dialog-Based Content Retrieval

One aspect of the present invention pertains to the delivery of content to a user based on interaction with a dialog-based interface. Dialog-based interaction is illustratively, though not restricted to, communication that is traditionally associated with person-to-person interactions. Dialog-based interaction includes, but is not limited to, instant message interaction, SMS messaging interaction, other chat-based interaction, email interaction, and telephone speech interaction.

Generally speaking, dialog-based interaction involves communication between a user device having a dialog-based interface and a communication service provider, typically over some form of a network. The communication service provider facilitates dialog-based communication between two users by facilitating communication between a first user device and a second user device. The basic idea is for a first user to use dialog to communicate with a second user.

In accordance with one aspect of the present invention, a user utilizes traditional, dialog-based interaction to request and receive information from a non-human source. The user interacts with the non-human source in a manner substantially similar to how they would typically interact with another person. One benefit of such an information retrieval system is that the infrastructure required to support such a dialog-based content retrieval system is essentially limited to the server side. The retrieval system requires little or no changes to be made to client devices and traditional systems for dialog-based interaction.

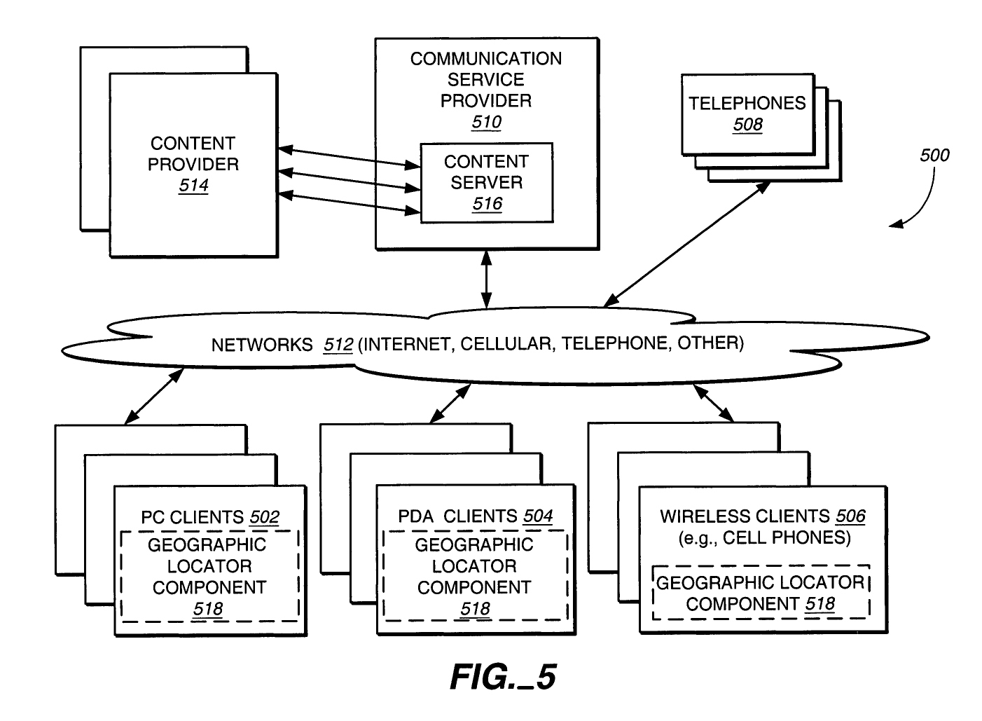

FIG. 5 is a schematic block diagram illustrating a dialog-based content retrieval system 500. Numerous user devices suitable for the present invention were described in relation to FIGS. 1-4. A representative few are illustrated in FIG. 5, namely, PC clients 502, PDA clients 504, wireless clients 506 (e.g., cell phones), and regular telephones 508. Devices 502, 504, 506 and 508 are all illustratively configured to interact with communication service provider 510 over a suitable and corresponding network 512.

The precise nature of communication service provider 510 will depend at least upon the nature of a given dialog-based interaction system. For example, instant message interaction will utilize an instant message service provider, as is known in the art. Email interaction will utilize an email transport service provider, as is known in the art. An SMS service provider will be utilized to support SMS interaction, as is known in the art. A specialized call service provider will support conventional telephone interaction, as is known in the art. Communication service provider 510 can illustratively be configured to support any type of dialog-based interaction and even multiple types of dialog-based interactions.

The nature of network 512 is variable and is partially dependent at least upon the nature of a given user device. For example, devices 502, 504 and 506 can be configured to communicate with service provider 510 over most networks including, but not limited to, a wireless network, the Internet, as well as any of the network configurations described in relation to FIGS. 1-4. Telephones 508 are illustratively configured to communicate with service provider 510 over an appropriate telephone network, as is known in the art.

Communication service provider 510 is illustratively further configured to enable a user of one of devices 502, 504, 506 or 508 to utilize traditional dialog-based interaction to communicate with, and make a request for content to, a non-human source. In accordance with one embodiment, the non-human source appears on an instant message “buddy list” and the user is able to dialog with the non-human source in the same manner that the user would dialog with another person. In accordance with another embodiment, the user is able to participate in a text message dialog with the non-human source. In accordance with another embodiment, the user dialogs with an automated system over telephone 508 in a manner that is similar to how the user would dialog with another person.

In accordance with one aspect of the present invention, in order to identify and fulfill requests for content, communication service provider 510 is configured to analyze messages directed to the non-human source and identify strings that represent commands. An example of an appropriate command language will be discussed below in Section V. identified commands are directed to a content server 516, which is illustratively responsible for compiling the requested content. In accordance with one embodiment, third party content providers 514 are configured to fill requests for content from content server 516 (e.g., XML feeds are supported between provider 514 and server 516).

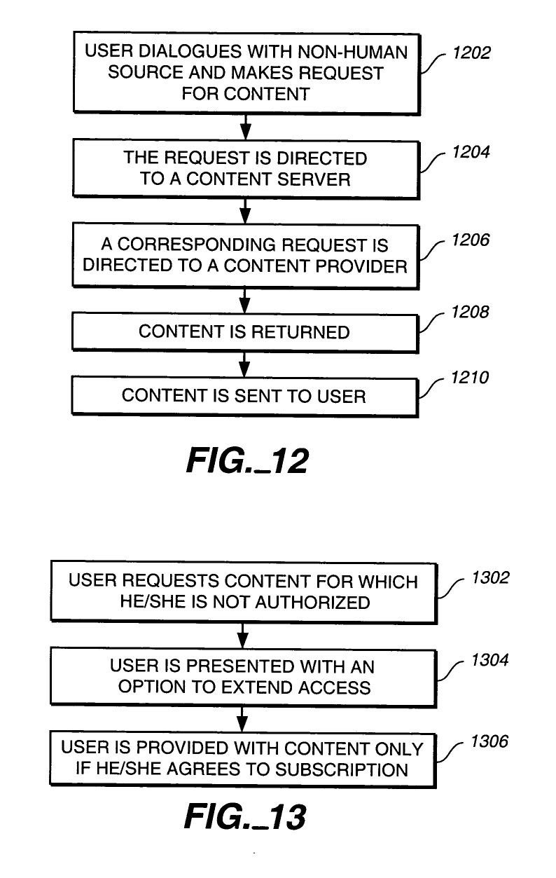

FIG. 12 is a flow chart illustrating the process of a user utilizing a dialog-oriented system to access information. In accordance with block 1202, a user dialogs with a non-human source and makes a request for information (e.g., a request for a particular sports score). In accordance with block 1204, the request is directed to content server 516. In accordance with block 1206, a corresponding request is made to a content provider 514 (e.g., an ESPN content provider). In block 1208, content provider 514 sends appropriate information to content server 516. The information is then forwarded back to the user to fulfill the request. In accordance with one embodiment, the content is presented to the user within a dialog response from the non-human source back to the user. It should be noted that not all content need come from a provider. Some or all content could just as easily be stored with content server 516, and be directly retrieved.

In accordance with one embodiment, users are allowed access to certain content (e.g., certain content providers, or certain types of content like traffic information, sports score, etc.) on a subscription basis. FIG. 13 is a flow chart illustrating a process of extending a user's access on a subscription basis. Generally speaking, when a user asks the non-human source for content for which the user has no authorization (block 1302), the non-human source is configured to offer to sell the user extended content access (block 1304). A user's profile and billing information is illustratively maintained with communication service provider 510. Appropriate billing information can be maintained with the user's profile information. The user might be billed on a per access basis (e.g., $5 for 50 searches), on an access-oriented basis (e.g., $5 per new content provider 514), or otherwise. In accordance with block 1306, the user is provided with the requested content only if he/she agrees to the additional fee. In accordance with one embodiment, a user may be provided with free access for a limited time, or for a limited number of searches, to “try out” certain services. After the limitations have expired, the user illustratively must pay or be denied further access.

In accordance with one embodiment, the content provided to a user is tailored to reflect certain parameters established in a profile maintained for that particular user. For example a request for weather information can be tailored to correspond to the user's city location or zip code. This is but one of many potential examples of a customized response. User profiles can be stored and maintained in many locations within the system but are illustratively stored and maintained with communication service provider 510. The profile might be specifically created to accommodate the dialog-based information retrieval process, or might be an existing profile created primarily for a given dialog interaction scheme (e.g., an instant messenger profile).

In accordance with another embodiment, content server 516 is configured to analyze requests for information over time and automatically construct a user profile for a given user. For example, if a user asks for the weather in Minneapolis four times within a month, then subsequent generic requests for weather will automatically relate to Minneapolis until and unless the user indicates that the assumption is in error. This is but one example of many automatic profile assumptions for which the system can be configured.

In accordance with one embodiment, content server 516 can be configured to tailor responses to requests for information to the particular location from which the request originates. For example, user devices 502, 504 and 506 are illustrated as having an optional geographic locator component (e.g., a GPS application, as is known in the art) stored thereon. The geographic locator component illustratively enables an indication of the location of the associated device to be transmitted, for example, with a dialog-based request for information. As an example of an application of this process, a user dialogs with a non-human source and asks for the weather. The content server collects and returns weather information for the particular location from which the request originated. This is but one example of the many potential applications of a geographic locator program within the framework of the overall system 500.

In accordance with one embodiment, communication service provider 510 can be configured to provide information to a user based on a reading of circumstances rather than in direct and immediate response to a request. For example, a user can illustratively dialog with a non-human source and direct it to provide information if and when an event occurs. For example, a user may instruct that alternate driving direction be provided if and when traffic becomes congested on a particular driving route. This is but one of many examples of information being provided based on a reading of circumstances.

In accordance with one embodiment, content server 516 is configure to provide a response to requests for information in a format appropriate for the device from which the request originated. Alternatively, however, a user can configure the system to provide responses in any format, and even to devices other than that from which a request originated.

The content retrieval system of the present invention is advantageous because the required client-side framework is minimal and existing. Little or no development is required on the client side. As the system is updated or added to, only the server side requires modification. A standard client interface is provided, thereby providing a standard way to access server content. Further, the system enables a user to interact with a content provider while they are at their PC or away from it. The interaction model is based on a human interaction model, which increases user friendliness. A user's input can even be relatively free natural language that is analyzed to glean commands and instructions. The content provider is potentially accessible from multiples interfaces, including chat, voice and email interfaces.

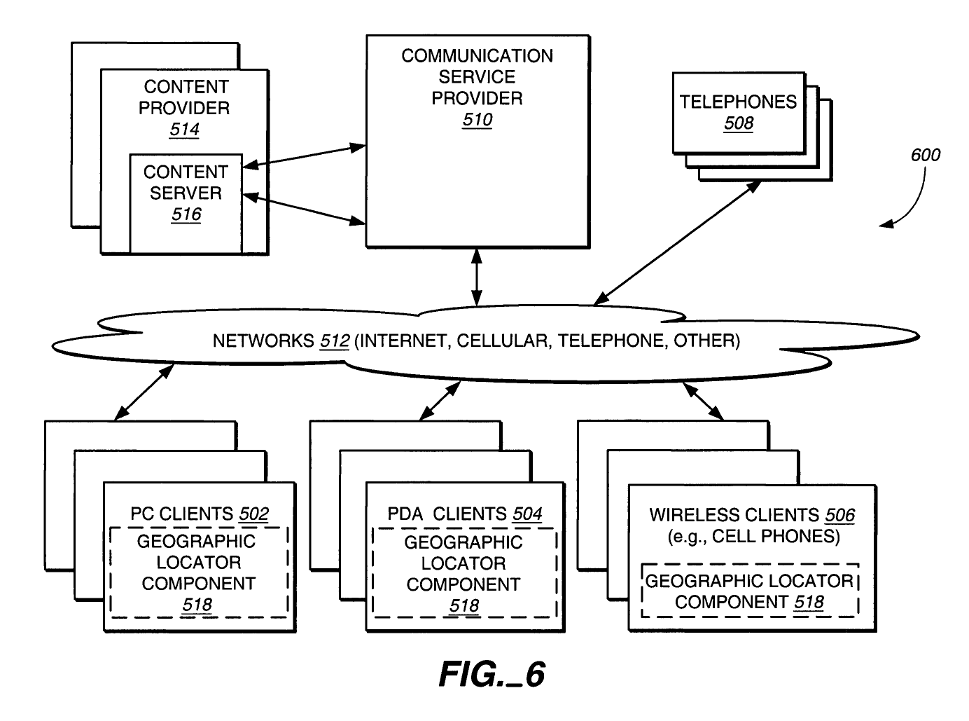

FIG. 6 is a schematic block diagram illustrating another dialog-based content retrieval system 600. Elements in FIG. 6 that are the same or substantially similar to elements illustrated and discussed in relation to FIG. 5 have been given the same reference numerals.

Within system 500, the communication service provider (e.g., an instant messaging service provider, an email transferring service provider, a telephone service provider, etc.) hosts the content server. Within system 600, one or more content providers host the content server. In the latter case, requests for content are directed to an appropriate content server 516 by communication service provider 510. The appropriate content server 516 compiles the information necessary to fulfill the request and forwards it to communication service provider 510 for transfer to the user who made the request.

V. Example of Dialog-Based Content Retrieval

In order to extend the description of the present invention to include additional details, a specific example of the already described dialog-based content retrieval system will now be described. The example will assume dialog-based communication in the particular form of instant messaging communication.

One aspect of the present invention generally pertains to a service that enables content to be transferred to any device that has an instant messaging client on it. It is generally known in the art that instant messaging communications can be initiated by selecting a contact buddy on a buddy list. The content transferred in accordance with the present invention is transferred through user interaction with a specialized buddy on the buddy list. In accordance with one embodiment, the specialized buddy appears to the user as “My Concierge.” The service converts user interactions with the specialized buddy into searches, which are utilized to obtain content that is fed to the service (e.g., from various content providers) using XML (or any other suitable means). The service uses key words to recognize the type of requested content. The service generally enables an Internet service provider to deliver content to any device that has an instant messaging client, for example, over SMS, Wireless Application Protocol (WAP), or dedicated client, without having additional client or service side requirements. The content delivery scheme includes a user-friendly, known interface. The scheme is positioned to take full advantage of future instant messaging features, such as voice, video, pictures and location.

A user is able to determine the availability of the service by looking at the status of his or her specialized buddy (e.g., determination is made as to whether “MyConcierge” is online, offline, busy, etc.). Assuming the specialized buddy is available, the user initiates instant message communication with the buddy. Once the conversation starts, the user illustratively asks questions such as “What's up?” or “What is . . . ?”. The service converts those questions to searches, and eventually, into content.

In accordance with one embodiment, the service utilizes key words to recognize a type of desired service. For example, “What is?” might signify that access to a knowledge-oriented service (e.g., Encarta by Microsoft Corporation of Redmond, Wash.) is desired. The knowledge-oriented service is assumedly a good source for answering “What is?” type questions. In another example, “Where is?” might signify that access to a geographic-oriented service (e.g., MapPoint by Microsoft) is desired.

In accordance with one embodiment, the service utilizes the existing instant messaging user profile and subsequent personalization to establish commonly used addresses for a specific user, as well as other preferences. The service is also configured to interact with the user through the specialized buddy in instant messaging format to ask personalizing questions such as “Where?” and can suggest response options such as “Home”, “Work”, or “Other (please enter zip code or city/state)” to collect relevant info in order to customize a response for a given user.

The service can illustratively be configured to use location aware devices and networks, when available, to enable a user to ask questions with a reference to “Here” as a location. The service then retrieves the current user location and provides location aware information.

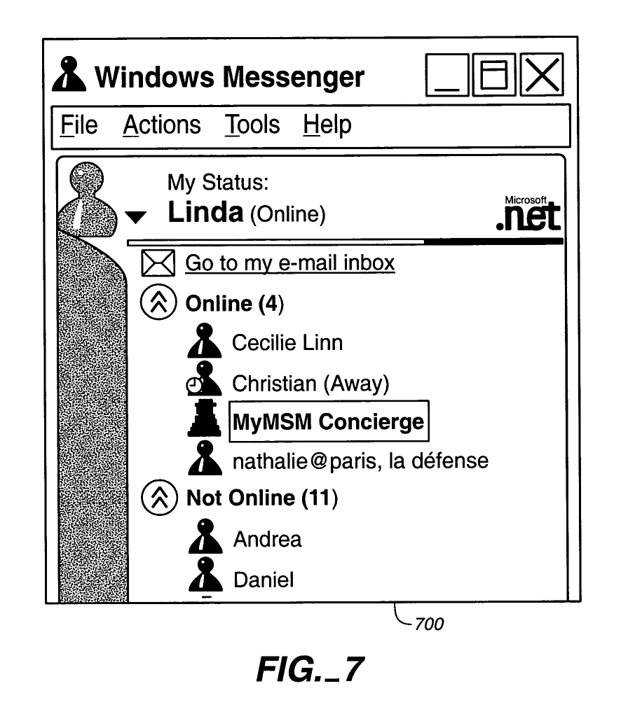

FIG. 7 is an illustration of a screen shot 700 in accordance with one embodiment of the present invention. The screen shot is intended to demonstrate how an instant messaging program can be utilized to deliver content. In accordance with the illustration, the described specialized buddy is listed on the user's (Linda's) buddy list as “MyMSNConcierge”. The provider of the instant messaging system can illustratively deliver content to any device that implements the client messaging software. In addition, the provider can provide content obtained from independent third parties. For example, XML based extensions to third party platforms can be generated to provide server/service for content providers. The content, like the messaging service itself, can be delivered over SMS, WAP, or dedicated client without having additional client side infrastructure.

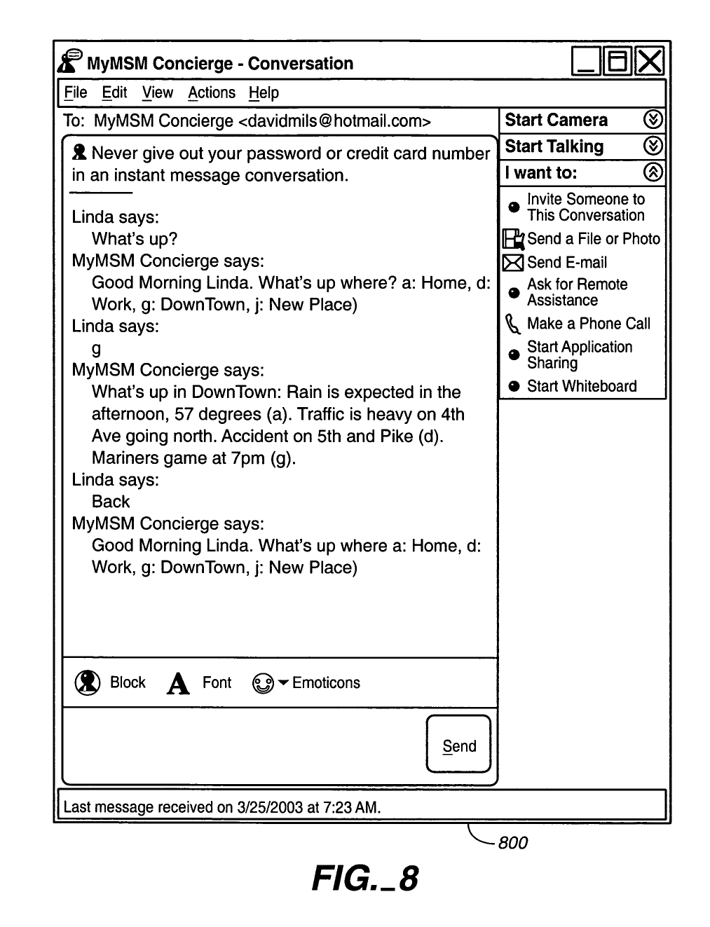

FIG. 8 is an illustration of a screen shot 800 in accordance with one embodiment of the present invention. Screen shot 800 is an example of a conversation between a user (Linda) and her specialized buddy (MyMSN Concierge). The user can illustratively preset preferences like common locations and other data of interest. The preferences can be saved to the service. Alternatively, data can be gleaned through conversation as the FIG. 8 conversation illustrates. In accordance with one embodiment, a user can enable a location selected option, wherein the user can select “here” as a location, and the service will default to the user's listed preferential location. By providing shortcut letters (a), (b), etc. as illustrated, the need for text input is minimized. Shot 800 shows the box at the bottom where the user inputs and enters text, as is known in the art.

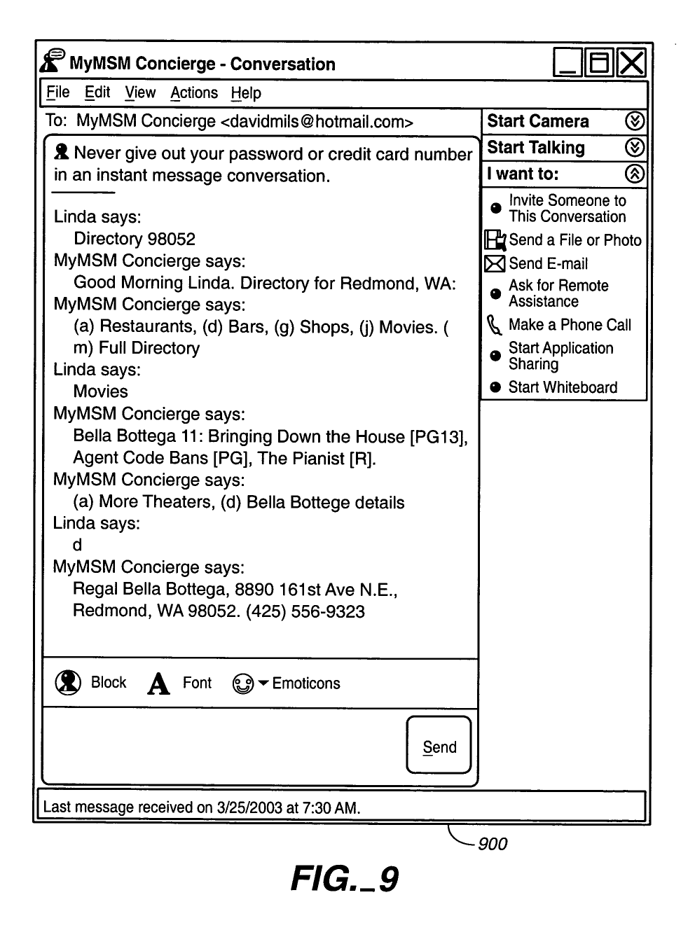

FIG. 9 is an illustration of a screen shot 900 in accordance with one embodiment of the present invention. In accordance with one aspect of the present invention, shot 900 demonstrates a user's ability to use short commands when communicating with their specialized buddy. As is illustrated by the sample conversation in the FIG. 9 screen shot, “directory” stands for access to yellow page directory information, “Where is?” stands for access to a geographic or map-oriented program for information, “What is?” stands for access to a knowledge-oriented program for information, “What's up?” stands for access to basic general information content, and “back” takes the user back to his or her first request. These are just a few of many potential examples of key words that can be assigned for various purposes.

It should be noted that creation of a new keyword or command is relatively simple because it requires nothing to happen on the client side. Only the server side must be updated to support new, or change, keywords. Users can also illustratively customize, create and assign their own keywords or commands with relative ease. The user's preferences can be saved for them on an individual basis.

In accordance with one embodiment, if a user attempts to access a service (e.g., a map program, a knowledge-oriented program, etc.) for which they are not signed up, the specialized buddy sends the user a link to upsell additional services.

VI. Dialog-Based Task Execution

In addition to providing content through a dialog-based service, the dialog-based service can also be utilized to collect instructions from a user to be executed on behalf of the user.

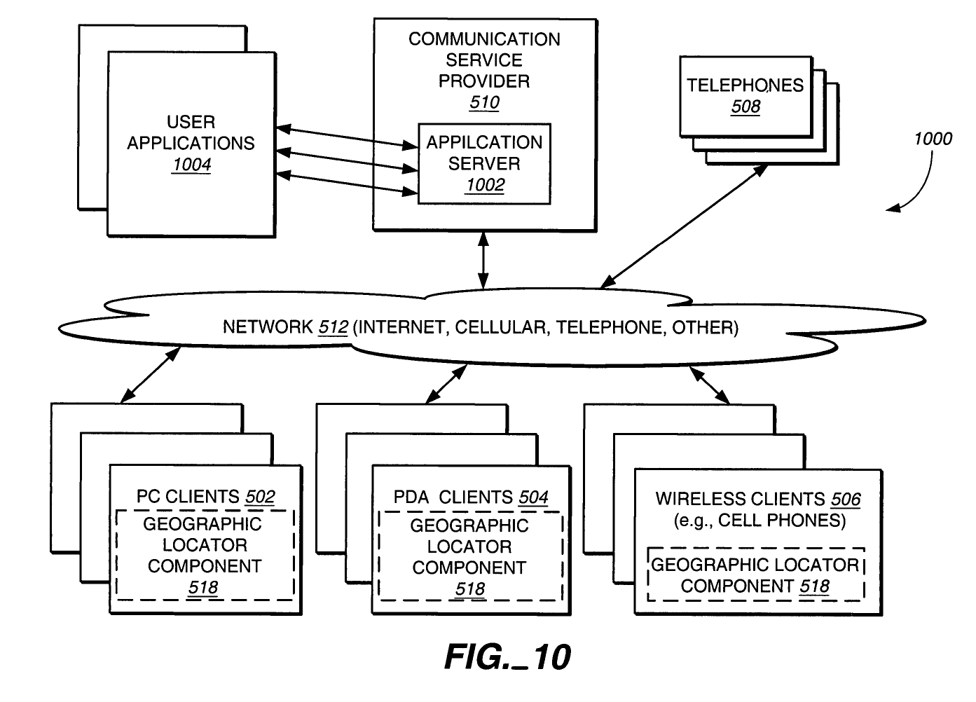

FIG. 10 is a schematic block diagram illustrating a task execution system 1000. Elements appearing in FIG. 10 that are the same or similar to elements previously described in relation to other Figures have been designated with the same reference numerals. Generally speaking, system 1000 operates in a manner that is substantially similar to system 500 described above. The primary difference is that the user's dialog directed to a specialized buddy is analyzed to extract tasks to be performed instead of content to be retrieved. In effect, the user can instruct the specialized buddy to act on his or her behalf to pay a bill, make a calendar appointment, or perform some other task. In this way, the user is spared having to access individual applications, and their association user interfaces, in order to perform the tasks manually. The task instructions identified from the user's dialog (e.g., using a keyword system similar to that described in relation to the content retrieval embodiments) are processed by application server 1002 and executed in association with user application programs 1004. Application programs 1004 might be stored locally with communication service provider 510, on the user's personal computing device or telephone, or in a remote network location.

Accordingly, another aspect of the present invention pertains to task-execution based on interaction with a dialog-based interface. A user utilizes traditional dialog-based interaction to interact with a non-human entity and request execution of a task. The user interacts with the non-human entity in a manner similar to how they would typically interact with another person.

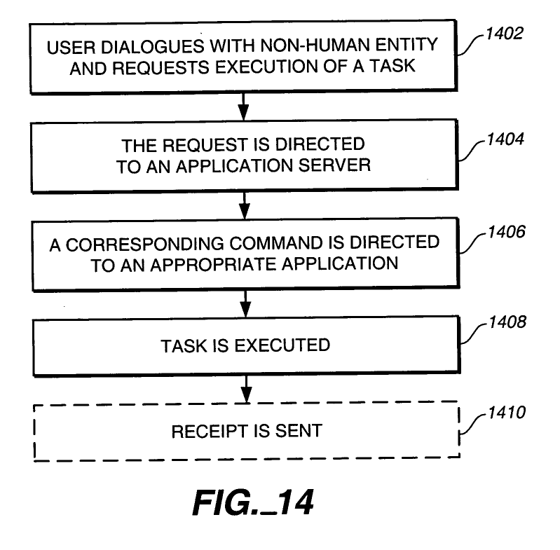

FIG. 14 is a flow chart illustrating the process of a user utilizing a dialog-oriented system to execute a task. In accordance with block 1402, a user dialogs with a non-human source and requests execution of a task (e.g., payment of a bill). The request is illustratively derived from the user's dialog based on a keyword command system similar to that described in relation to content retrieval. The system can be configured to dialog back and forth with the user to ascertain accurate instructions. In accordance with block 1404, the request is directed to application server 1002. In accordance with block 1406, a corresponding command is directed to an appropriate application 1004. In accordance with block 1408, the task is executed. Block 1410 represents an optional step wherein a receipt is sent to the user indicating what task was performed and when.

It should be noted that a task-execution system and a content retrieval system can be combined into a single system and presented to a user in a uniform manner. It should be noted that task execution services could be extended to the user on a subscription basis as described in relation to the content retrieval embodiments. Also, user profiles and preferences can be utilized as described to customize the task-execution process. Task execution can be configured to be triggered circumstantially (e.g., pay the bill if it is past May 25, etc.).

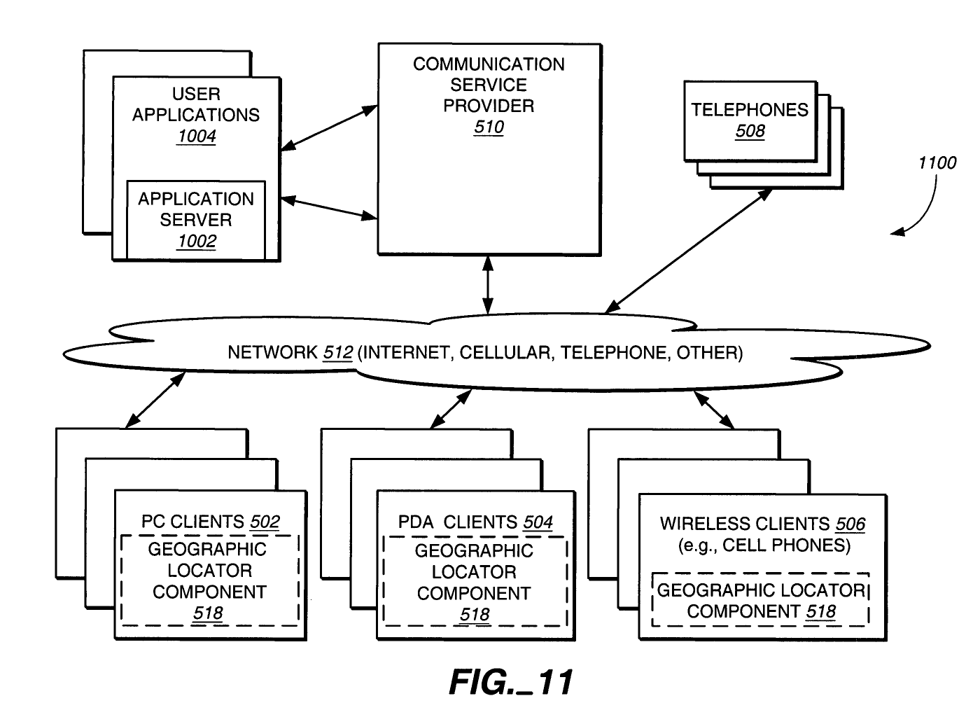

FIG. 11 is a schematic block diagram illustrating another dialog-based task-execution system 1100. Elements in FIG. 11 that are the same or substantially similar to elements discussed in relation to previous Figures have been assigned the same reference numerals.

Within system 1000, the communication service provider (e.g., an instant messaging service provider, an email transferring service provider, a telephone service provider, etc.) hosts the application server. Within system 1100, one or more user applications host an application server. In the latter case, requests for task-execution are directed to an appropriate application server by communication service provider 510. The appropriate application server arranges for execution of the task. Confirmation of task execution can be forwarded to communication service provider 510 and/or the user. It is to be understood that task-execution can be geographically tailored (e.g., order me a pizza and have it delivered here) in the essentially same manner as was described in relation to content delivery.

It should be noted that email interaction could be utilized to support either of the described content retrieval and task-execution systems. In accordance with one embodiment of such a system, a user sends an email to a simulated entity in order to request content or performance of a task. The email service provider includes infrastructure to analyze the text of the email (e.g., parsing out information) sent to the simulated entity and identify key words or commands, which may or may not be the same key words as utilized in a chat-oriented scenario. The commands are executed as described in relation to other embodiments. Requested content can be transferred to the user through email or otherwise, depending on the user's preferences.

Although the present invention has been described with reference to particular embodiments, workers skilled in the art will recognize that changes may be made in form and detail without departing from the spirit and scope of the invention.

1. A computer implemented method for task execution based on dialog-based communication with a communication service, comprising:
receiving dialog from a user, the dialog being directed to a specialized entity;
analyzing the dialog to identify a command; and
performing a task on the user's behalf based on the command.

2. The method of claim 1, wherein analyzing the dialog to identify a command comprises analyzing the dialog to determine which of a variety of applications is necessary to complete the task.

3. The method of claim 2, further comprising determining whether the user is authorized to utilize the application necessary to complete the task, and performing the task only if the user is authorized.

4. The method of claim 3, further comprising presenting the user with an opportunity to become authorized when the user is not authorized to utilize the application necessary to complete the task.

5. The method of claim 4, wherein presenting the user with an opportunity to become authorized comprises presenting the user with an opportunity to purchase access.

6. The method of claim 1, further comprising utilizing the specialized entity to participate in dialog interaction with the user to guide the user in the production of said dialog.

7. The method of claim 6, wherein utilizing the specialized entity to participate in dialog interaction with the user comprises:
presenting the user with a plurality of choices; and
receiving from the user a selection of one of the plurality of choices.

8. The method of claim 7, wherein performing a task on the user's behalf comprises performing a task tailored to the selection of one of the plurality of choices.

9. The method of claim 1, wherein performing a task on the user's behalf comprises performing a task tailored to a parameter listed in a profile associated with the user.

10. The method of claim 1, wherein performing a task on the user's behalf comprises performing a task tailored to a preference associated with the user.

11. The method of claim 10, wherein the preference is set by the user.

12. The method of claim 10, wherein the preference is automatically set based on a history of user interactions with the specialized entity.

13. The method of claim 1, further comprising determining a geographic location of a device with which the user is communicating with the communication service.

14. The method of claim 13, wherein performing a task on the user's behalf comprises performing a task tailored to the geographic location.

15. The method of claim 1, wherein the communication service is an instant message communication service, and wherein receiving dialog from the user comprises receiving instant message dialog.

16. The method of claim 15, wherein the dialog is directed to a specialized buddy appearing on an instant messaging buddy list associated with the user.

17. The method of claim 1, wherein the communication service is a text messaging communication service, and wherein receiving dialog from the user comprises receiving text messaging dialog.

18. The method of claim 1, wherein the communication service is an email transport service, and wherein receiving dialog from a user comprises receiving an email addressed to the specialized recipient.

19. The method of claim 18, wherein analyzing the dialog to identify a command comprises parsing a textual content of the email.

20. The method of claim 1, wherein the communication service is an automated telephone system, and wherein receiving dialog from a user comprises receiving speech communication.

21. The method of claim 1, wherein analyzing the dialog to identify a command comprises analyzing the dialog to identify a keyword.

22. The method of claim 1, wherein performing a task on the user's behalf comprises interfacing with a software application on behalf of the user to perform a task.

23. The method of claim 1, wherein performing a task on the user's behalf comprises sending an action command to instruct a software application to take action on the user's behalf.

24. The method of claim 1, wherein performing a task on the user's behalf comprises interfacing with a calendar software application.

25. The method of claim 1, wherein execution of the command is contingent upon a set of predetermined circumstances, and wherein performing a task on the user's behalf comprises performing a task when the predetermined set of circumstances have occurred.

26. A computer implemented method for directing a server, comprising:
requesting performance of a task by way of dialog-based communication directed through a communication service to a specialized entity.

27. The method of claim 26, wherein requesting performance of a task comprises transmitting a command to access one of a plurality of applications.

28. The method of claim 26, wherein requesting performance of a task comprises selecting one of a plurality of choices presented through a user interface associated with the communication service.

29. The method of claim 28, wherein the task is tailored to the selected one of the plurality of choices.

30. The method of claim 26, further comprising:
configuring a user profile; and
wherein requesting performance of a task comprises requesting performance of a task tailored to a parameter listed in the user profile.

31. The method of claim 26, wherein requesting performance of a task comprises requesting performance of a task tailored to a user preference.

32. The method of claim 31, wherein requesting performance of a task tailored to a user preference comprises requesting performance of a task tailored to a preference set by the user.

33. The method of claim 31, wherein requesting performance of a task tailored to a user preference comprises requesting performance of a task tailored to a preference that is automatically set based on a history of user interactions.

34. The method of claim 26, wherein requesting performance of a task by way of dialog-based communication directed through a communication service to a specialized entity comprises requesting performance of a task by way of instant messaging communication directed through an instant messaging service.

35. The method of claim 34, wherein requesting performance of a task by way of dialog-based communication directed through an instant messaging communication service to a specialized entity comprises requesting performance through the instant messaging service to a specialized buddy appearing on an instant messaging buddy list.

36. The method of claim 26, wherein requesting performance of a task by way of dialog-based communication directed through a communication service to a specialized entity comprises requesting performance of a task by way of text messaging dialog directed through a text messaging communication service.

37. The method of claim 26, wherein requesting performance of a task by way of dialog-based communication directed through a communication service to a specialized entity comprises requesting performance of a task by way of an email message addressed to the specialized entity and directed through an email transport service.

38. The method of claim 26, wherein requesting performance of a task by way of dialog-based communication directed through a communication service to a specialized entity comprises requesting performance of a task by way of telephone dialog directed through an automated telephone system.

39. The method of claim 26, wherein requesting performance of a task comprises requesting that a software application be accessed to perform a task on behalf of a user.

40. The method of claim 26, wherein requesting performance of a task comprises requesting that an action command be forwarded to instruct a software application to take action on behalf of a user.

41. The method of claim 26, wherein requesting performance of a task comprises requesting performance of a task contingent upon a set of predetermined circumstances, wherein performance of the task happens when the predetermined set of circumstances have occurred.

42. A client-server system that enables a user to initiate task-execution through dialog-based communication with a specialized entity, comprising:
a server having a communication service provider implemented thereon;
a client device configured to enable the user to utilize dialog-based communication to interact with a specialized entity through the communication service provider, the communication service provider being configured to support the recognition and execution of a command communicated through the dialog-based communication with the specialized entity, the command being a direction to perform a task on the user's behalf.

43. The system of claim 42, wherein the recognition and execution of a command comprises determining which of a variety of applications is necessary to complete the task on the user's behalf.

44. The method of claim 42, wherein the communication service provider is further configured to utilize the specialized entity to participate in dialog interaction with the user to guide the user towards a submission of the command.

45. The method of claim 44, wherein utilizing the specialized entity to participate in dialog interaction with the user comprises:
presenting the user with a plurality of choices; and
receiving from the user a selection of one of the plurality of choices.

46. The method of claim 45, wherein performing a task on the user's behalf comprises performing a task tailored to the selection of one of the plurality of choices.

47. The method of claim 42, wherein performing a task on the user's behalf comprises performing a task tailored to a preference associated with the user.

48. The method of claim 47, wherein the preference is set by the user.

49. The method of claim 47, wherein the preference is automatically set based on a history of user interactions with the specialized entity.

50. The method of claim 42, wherein the client device further comprises a system for determining a geographic location of the client device.

51. The method of claim 50, wherein performing a task on the user's behalf comprises performing a task tailored to the geographic location.

52. The method of claim 42, wherein the communication service provider is an instant message communication service, and wherein the dialog-based communication is instant messaging communication.

53. The method of claim 52, wherein the specialized entity is a specialized buddy appearing on an instant messaging buddy list associated with the user.

54. The method of claim 42, wherein the communication service provider is a text messaging communication service, and wherein the dialog-based communication is text messaging communication.

55. The method of claim 42, wherein the communication service provider is an email transport service, and wherein the dialog-based communication is an email addressed to the specialized entity.

56. The method of claim 42, wherein the communication service provider is an automated telephone system, and wherein the dialog-based communication is telephone communication.

57. The method of claim 42, wherein performing a task on the user's behalf comprises interfacing with a software application on behalf of the user to perform a task.

58. The method of claim 42, wherein performing a task on the user's behalf comprises sending an action command to instruct a software application to take action on the user's behalf.

59. The method of claim 42, wherein performing a task on the user's behalf comprises interfacing with a calendar software application.
